(19) United States
(12) Patent Application Publication
(10) Pub. No.: US 2022/0300893 A1
(43) Pub. Date: Sep. 22, 2022

(54) SYSTEMS AND METHODS FOR COORDINATION OF ASSET PROCUREMENT TRANSACTIONS

(71) Applicant: 12771888 Canada Inc., Mississauga (CA)

(72) Inventor: Ryan P. DAVIDSON, North York (CA)

(21) Appl. No.: 17/640,718

(22) PCT Filed: Sep. 8, 2020
(86) PCT No.: PCT/IB2020/000721

§ 371 Date: Mar. 4, 2022

Related U.S. Application Data
(60) Provisional application No. 62/897,052, filed on Sep. 6, 2019.

(51) Int. Cl. G06Q 10/08; G06Q 30/06; G06Q 30/02

(52) U.S. Cl. CPC G06Q 10/087; G06Q 30/0601; G06Q 30/0207

(57) ABSTRACT

Systems and methods for automated coordination of asset procurement transactions are disclosed. Systems and methods include receiving transaction information for the asset procurement transaction. The transaction information identifies a type of asset procurement transaction, an asset being procured, and parties to the transaction. The method further includes determining, based on status information received while the asset procurement is pending, a current step of the transaction, a next step of the transaction, and an action required to advance the transaction to the next step. The method further includes providing a user interface to a party to the transaction via a computing device of the party and providing, via the user interface, a prompt enabling the party to perform the action using the user interface.

### CROSS-REFERENCES TO RELATED APPLICATIONS

This application claims priority to and benefit from the filing date of U.S. Provisional Patent Application No. 62/897,052 entitled “Systems and Methods for Coordination of Asset Procurement Transactions” and filed on Sep. 6, 2019.

### STATEMENT REGARDING FEDERALLY SPONSORED RESEARCH

Not Applicable.

### BACKGROUND

The present disclosure relates generally to systems and methods for coordination of procurement, sales, and delivery of physical assets in transactions with multiple parties.

Complex procurement and sales transactions are frequently completed manually by humans who may use various electronic communications systems and other tools to automate portions of the process. For example, an importer may contact various exporters to locate desired products such as automobiles, boats, airplanes, etc. The importer negotiates pricing with the exporter and the parties make arrangements for sending, processing, and receipt of payment. The importer and/or the exporter must determine how the item(s) will be transported and arrange for transportation which may involve contracting with third parties. The various parties to the transaction must also arrange for filing of necessary information with government entities and payment of various fees, taxes, and/or duties.

These previous methods can be difficult, time-consuming, and inefficient due to the need to coordinate between at least two parties, and frequently many more than two parties, each of whom may reside in different countries, speak different languages, and use different currencies than the other parties. Furthermore, various parties may use discrete computing systems to help manage aspects of purchasing and delivery processes which are frequently not configured to interoperate.

### BRIEF SUMMARY

The present disclosure provides systems and methods for coordination of asset procurement transactions. In an aspect, an asset procurement coordination system comprises processing circuitry and memory coupled to the processing circuitry, the memory storing machine-readable instructions which, when executed by the processing circuitry, cause the processing circuitry to receive transaction information the asset procurement transaction. The transaction information identifies a type of asset procurement transaction, an asset being procured, and parties to the transaction. Execution of the instructions further cause the processing circuitry to determine, based on status information received by the processing circuitry while the asset procurement is pending, a current step of the transaction, a next step of the transaction, and an action required to advance the transaction to the next step. Execution of the instructions further cause the processing circuitry to provide a user interface to a party to the transaction via a computing device of the party and to provide via the user interface, a prompt enabling the party to perform the action using the user interface.

In another aspect, an asset procurement coordination system includes processing circuitry and memory coupled to the processing circuitry. The memory stores machine-readable instructions that, when executed by the processing circuitry, cause the processing circuitry to receive, via a user interface of a user device, vehicle identification information identifying a particular vehicle. When executed by the processing circuitry, the instructions further cause the processing circuitry to determine, using the vehicle identification information, characteristic values indicating characteristics of the particular vehicle. When executed by the processing circuitry, the instructions further cause the processing circuitry to retrieve, from a first electronic datastore, for each region belonging to a set of geographic regions, vehicle sales records, indicating vehicles purchased by one or more buyers in that region, and characteristics of the vehicles purchased by the one or more buyers in that region. When executed by the processing circuitry, the instructions further cause the processing circuitry to determine for each region, using at least the characteristics of the particular vehicle. When executed by the processing circuitry, the instructions further cause the processing circuitry to determine similar sales records for that region corresponding to vehicles similar to the particular vehicle and an expected sales price of the particular vehicle in that region using the similar sales records for that region. When executed by the processing circuitry, the instructions further cause the processing circuitry to cause the user interface of the user device to display offers to purchase the particular vehicle at the expected sales price for one or more regions of the set of geographic regions.

In yet another aspect, a computer-implemented method for coordinating steps in an asset procurement transaction is provided. The method includes receiving transaction information the asset procurement transaction. The transaction information identifies a type of asset procurement transaction, an asset being procured, and parties to the transaction. The method further includes determining, based on status information received while the asset procurement is pending, a current step of the transaction, a next step of the transaction, and an action required to advance the transaction to the next step. The method further includes providing a user interface to a party to the transaction via a computing device of the party and providing, via the user interface, a prompt enabling the party to perform the action using the user interface.

In yet another aspect, a computer-implemented method of automatically coordinating asset procurement includes receiving, via a user interface of a user device, vehicle identification information identifying a particular vehicle. The method further includes determining, using the vehicle identification information, characteristic values indicating characteristics of the particular vehicle. The method further includes retrieving, from a first electronic datastore, for each region belonging to a set of geographic regions, vehicle sales records, indicating vehicles purchased by one or more buyers in that region, and characteristics of the vehicles purchased by the one or more buyers in that region. The method further includes determining for each region, using at least the characteristics of the particular vehicles, similar sales records that correspond to vehicles similar to the particular vehicle and an expected sales price of the particular vehicle in that region using the similar sales records for that region. The method further includes transmitting an electronic message causing the user interface of the user device to display offers to purchase the particular vehicle at the expected sales price for one or more of the regions.

In yet another aspect a computer program product is provided. The computer program product includes a non-transitory storage medium storing machine-readable instructions. The instructions are configured to cause processing circuitry of a computing device executing the instructions to receive, via a user interface of a user device, vehicle identification information identifying a particular vehicle. The instructions are further configured to cause the processing circuitry to determine, using the vehicle identification information, characteristic values indicating characteristics of the particular vehicle. The instructions are further configured to cause the processing circuitry to retrieve, from a first electronic datastore, for each region belonging to a set of geographic regions, vehicle sales records indicating vehicles purchased by one or more buyers in that region, and characteristics of the vehicles purchased by the one or more buyers in that region. The instructions are further configured to cause the processing circuitry to determine for each region, using at least the characteristics of the particular vehicle, similar sales records that correspond to vehicles similar to the particular vehicle and an expected sales price of the particular vehicle in that region using the similar sales records for that region. The instructions are further configured to cause the processing circuitry to transmit an electronic message causing the user interface of the user device to display offers to purchase the particular vehicle at the expected sales price for one or more of the regions.

In yet another aspect, an asset procurement coordination system is provided. The system includes processing circuitry and memory coupled to the processing circuitry, the memory storing machine-readable instructions that, when executed by the processing circuitry, cause the processing circuitry to receive, via a user interface of a user device, vehicle identification information identifying a particular vehicle. When executed by the processing circuitry, the instructions further cause the processing circuitry to determine, using the vehicle identification information, characteristic values indicating technical characteristics of the particular vehicle. When executed by the processing circuitry, the instructions further cause the processing circuitry to retrieve, from a first electronic datastore, for each region belonging to a set of geographic regions, vehicle properties, indicating one or a group of vehicles having similar properties, and the technical characteristics of the one or group of vehicles having similar vehicle properties in that region. When executed by the processing circuitry, the instructions further cause the processing circuitry to determine for each region, using at least the technical characteristics of the particular vehicle, similar vehicles with similar properties for that region corresponding to vehicles technically similar to the particular vehicle, and an expected calculated property of the particular vehicle in that region using the vehicles with similar properties for that region. When executed by the processing circuitry, the instructions further cause the processing circuitry to cause the user interface of the user device to display the particular vehicle with the expected calculated property for one or more regions of the set of geographic regions.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims herein for interpreting the scope of the disclosure.

### BRIEF DESCRIPTION OF DRAWINGS

The invention will be better understood and features, aspects, and advantages other than those set forth above will become apparent when consideration is given to the following detailed description thereof. Such detailed description makes reference to the following drawings.

FIG. 1 is schematic views of an asset procurement system according to aspects of the present disclosure.

FIG. 2 is a schematic-level flow diagram of an example method of automating asset procurement according to aspects of the present disclosure.

FIG. 3 is a flow diagram of an additional example method of automating asset procurement according to aspects of the present disclosure.

FIGS. 4A-4C are pictorial views of example user interface displays (“UIDs”) provided by the systems and methods of FIGS. 1A-B.

FIG. 5 is a pictorial view of an example UID provided by the systems and methods of FIGS. 1A-B allowing users to communicate as part of a prospective sale transaction.

FIG. 6 is a pictorial view of an example UID provided by the systems and methods of FIG. 1A allowing a user to review the status of a sale transaction.

FIGS. 7A-7F are pictorial views of example UIDs provided by the systems and methods of FIGS. 1-2 during the course of processing a sale transaction.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

While various spatial and directional terms, such as “top,” “bottom,” “lower,” “mid,” “lateral,” “horizontal,” “vertical,” “front,” and the like may be used to describe examples of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Within this Specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

For instance, it should be understood that, although this disclosure makes reference to various activities such as procuring, purchasing, importing, exporting, and so on in relation to automobiles, references to automobiles are intended as non-limiting examples, and that the functionality and benefits disclosed herein may be applied to a wide range of business and other transactions.

For purposes of this application, the term “processing circuitry” shall mean a presently developed or future developed processing circuitry that executes sequences of instructions contained in a memory. Execution of the sequences of instructions causes the processing circuitry to perform steps such has generating control signals. The instructions may be loaded in a random access memory (RAM) for execution by the processing circuitry from a read only memory (ROM), a mass storage device, or some other persistent storage. In other embodiments, hard wired circuitry may be used in place of or in combination with software instructions to implement the functions described. For example, all or part of the processing circuitry may be embodied as part of one or more application-specific integrated circuits (ASICs). Unless otherwise specifically noted, aspects of the processing circuitry disclosed herein are not limited to any specific combination of hardware circuitry and software, nor to any particular source for the instructions executed by the processing circuitry. Computing devices disclosed herein may comprise portable electronic devices such as a smart phone, laptop computer, tablet computer or other portable electronic device by which data may be manually or audibly input.

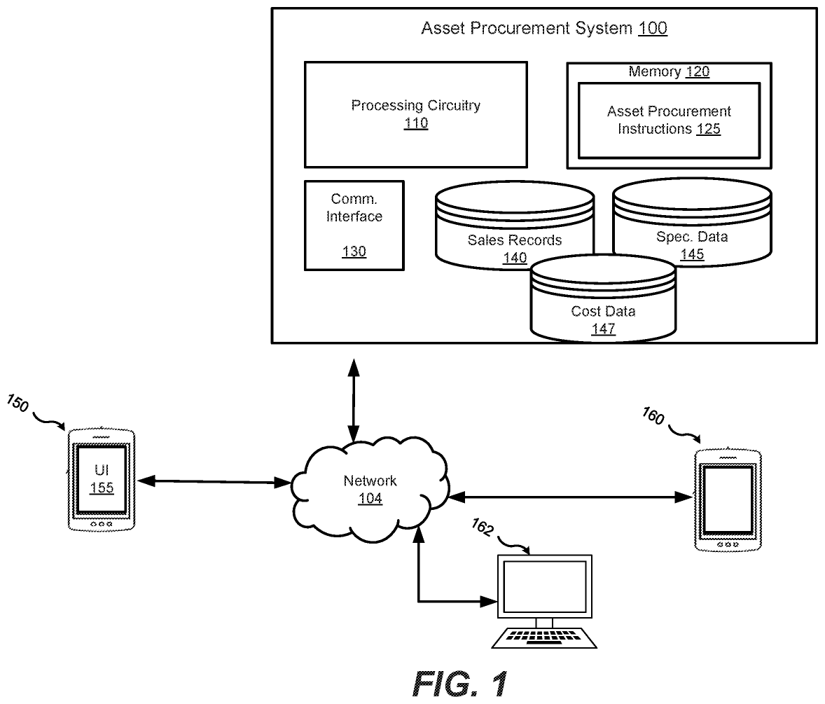

FIG. 1 is block-level system diagram of an example asset procurement system 100 in communication with a user devices 150 and additional user devices 160, 162 via a network 104 such as the Internet, a LAN, or WAN as nonlimiting examples. FIG. 1B is a schematic-level flow diagram of aspects of an example system and associated method 100 for automatically managing procurement of assets such as automobiles.

The asset procurement system 100 may comprise processing circuitry 110 and memory 120 coupled to the processing circuitry 110 and storing machine-readable instructions (e.g., the asset procurement instructions 125) which, when executed by the processing circuitry, may cause the processing circuitry to perform methods disclosed herein. The processing circuitry 110 may reside within one or more computing devices such as personal computers, servers, and/or mobile devices such as mobile phones and tablets. The processing circuitry may processing circuitry comprise physical computing devices and virtualized computing devices operating as software on physical computing devices. The processing circuitry may also comprise distributed systems of multiple computing devices communicating over a data network such as the Internet (i.e., a “cloud” computing environment). The asset procurement system 100 may include a communication interface 130 coupled to the processing circuitry 110 and may be configured to communicate internally and with external computing devices via wired and/or wireless networks including LANs and WANs, using protocols including Ethernet, Bluetooth, Wi-Fi, LTE, infrared, and others.

The asset procurement system 100 may include, or may otherwise be provided with access to, one or more datastores storing sales records 140 corresponding to sales previously processed by the asset procurement system 100 and/or obtained from other sources. The asset procurement system 100 may also include, or may otherwise be provided with access to, one or more datastores storing specification records 145 corresponding to requirements for sale of assets under different circumstances, as will be described further below. The asset procurement system 100 may also include, or may otherwise be provided with access to, one or more datastores storing cost data 147 corresponding to costs of completing transactions under different circumstances as described further below. Non-limiting examples of cost data include transaction processing fees, import and/or export duties, transportation costs, currency conversion costs, costs to modify assets for sale in different regions, and so on.

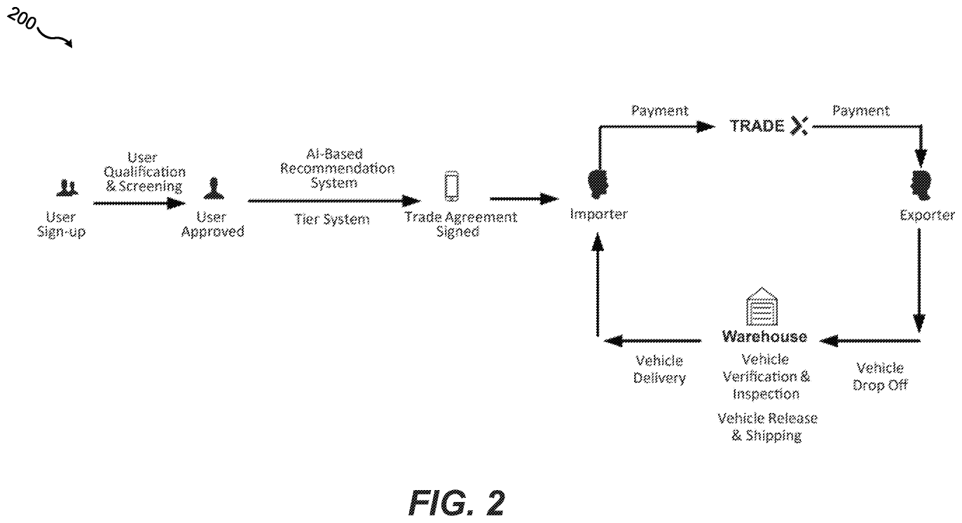

As illustrated by the example method 200 in FIG. 2, the asset procurement system 100 can enroll users and can screen and qualify them. Suitable users can be approved by the asset procurement system 100. The asset procurement system 100 can use machine learning and other artificial intelligence (AI) techniques to identify user preferences and make recommendations. For example, the asset procurement system 100 may recommend available vehicles being offered by particular users who are exporters to a particular user who is an importer. These recommendations may be based on user preferences entered directly by the users and/or based upon previous activity of the particular user(s) and/or activity of related users. Transactions may also be associated with particular assets and form the basis for recommendations. For instance, car A may share technical characteristics with car B which allow the asset procurement system 100 to infer that a user interested in procuring car A may be interested in procuring car B in addition to car A or instead of car A. Data about vehicles, shipping rates, and other relevant information may be obtained automatically by the system by interfacing with other electronic systems over wired and wireless communications networks.

As further illustrated by the example method 200, the asset procurement system 100 may determine the likelihood that a particular user will respond to an offer or recommendation using AI-enabled predictive modeling performed by recommendation engine implemented as part of the asset procurement system 100. The recommendation engine may present recommendations and/or alter user interfaces displays to respond to imputed user preferences as well as to optimize other metrics such as offer conversion rates or user retention rates. The asset procurement system 100 may utilize historical and other data to determine key features in available data which are most useful in predicting user behaviors and the impact of predicted behaviors on desired metrics.

In some embodiments, offline resources may be integrated into the online system to ensure synchronization of order information. For instance, data may be manually entered from other sources or retrieved via an API call at an earlier time. Users can simply choose vehicle pictures and information to publish the complete model information in the platform. At the same time, real-time shipping information and exchange rate can be generated by checking users' location and destination locations.

As further illustrated by the example method 200, the asset procurement system 100 can process payment on behalf of the buyer and deliver payment to the seller. The system may track the progress of the transaction and may coordinate various steps of the transaction. In the example of an international vehicle sale, the system can automate coordination between the parties, providing, for example, instruction for depositing the vehicle being sold at a shipper's warehouse, inspection of the vehicle and shipment of the vehicle to the buyer.

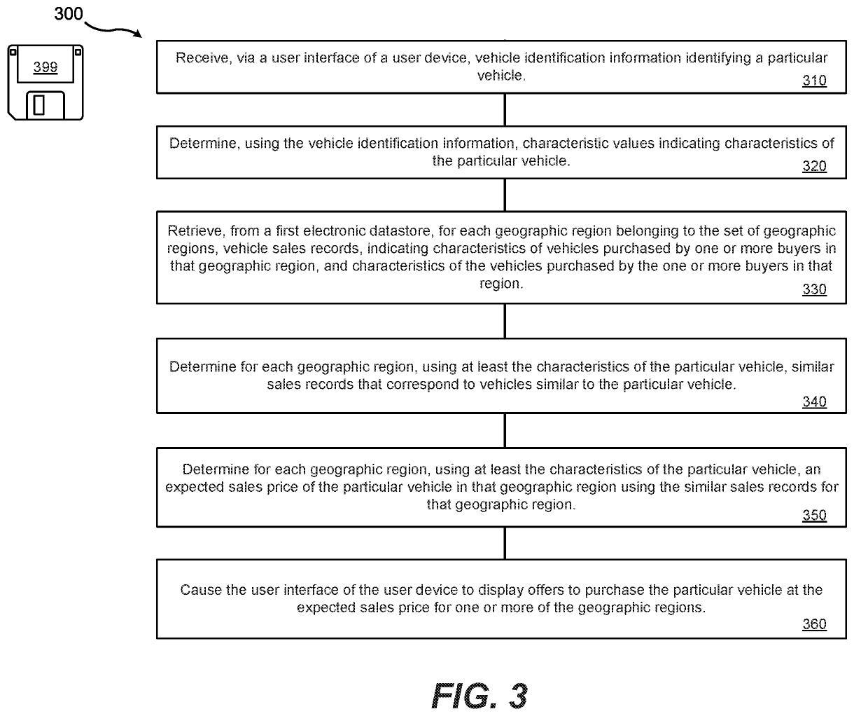

FIG. 3 shows a block-level flow diagram of an example method 300 having steps 310, 320, 330, 340, 350, and 360. In some embodiments, a non-transitory storage medium (e.g., the medium 399) includes machine readable instructions (e.g., the asset procurement instructions 152) for carrying out the method 300. In some examples, the method 300 may be performed by a processor (e.g., the processing circuitry 110) of an asset procurement system or other suitable computing device (e.g., the asset procurement system 100).

At step 310, the processor receives (using a communication circuitry such as the communication interface 130), via a user interface of a user device (e.g., the user interface 155 of the user device 150), vehicle identification information identifying a particular vehicle. As a non-limiting example the vehicle identification information be a serial number, Vehicle Identification Number (VIN), a vehicle registration number, or alphanumeric data identifying a year, make, and model that may also include additional information such as color, condition, and features of the particular vehicle.

At step 320 the processor may determine, using the vehicle identification information, characteristic values indicating characteristics of the particular vehicle, including technical characteristics including vehicle parameters or properties. These values may include, as nonlimiting examples the year, make and model of the particular vehicle, the date and location of manufacture of the particular vehicle, and technical configuration details of the vehicle, which the processor determines are required to identify information relating to similar vehicles used at steps 340 and 350.

At step 330, the processor may retrieve, from a first electronic datastore, for each geographic region belonging to the set of geographic regions, vehicle sales records (e.g., the vehicle sales records 140) indicating characteristics of vehicles purchased by one or more buyers in that geographic region, and characteristics of the vehicles purchased by the one or more buyers in that region.

At step 340, the processor may determine for each geographic region, using at least the characteristics of the particular vehicle, similar sales records belonging to the vehicle sales record that correspond to vehicles similar to the particular vehicle.

At step 350, using the similar sales records determined at step 340, the processor may determine, for each geographic region, using at least the characteristics of the particular vehicle, an expected sales price of the particular vehicle in that geographic region. The expected sales prices for each geographic region may be calculated as an average of sales prices of the similar sales records or using any other suitable method. As one non-limiting example, the processor may perform a principal component analysis (PCA) to determine vehicles characteristics (e.g., color, option, mileage, new vs. used, et al.) that are the best predictors of total sales price for a particular vehicle make and model, determine an equation for sales price using those predictors, and apply that equation to the characteristics of the particular vehicle to predict an expected sales price for each region. The processor may also employ supervised or unsupervised learning algorithms to predict expected sales prices based on previous sales records and characteristic values of vehicles associated with those sales records.

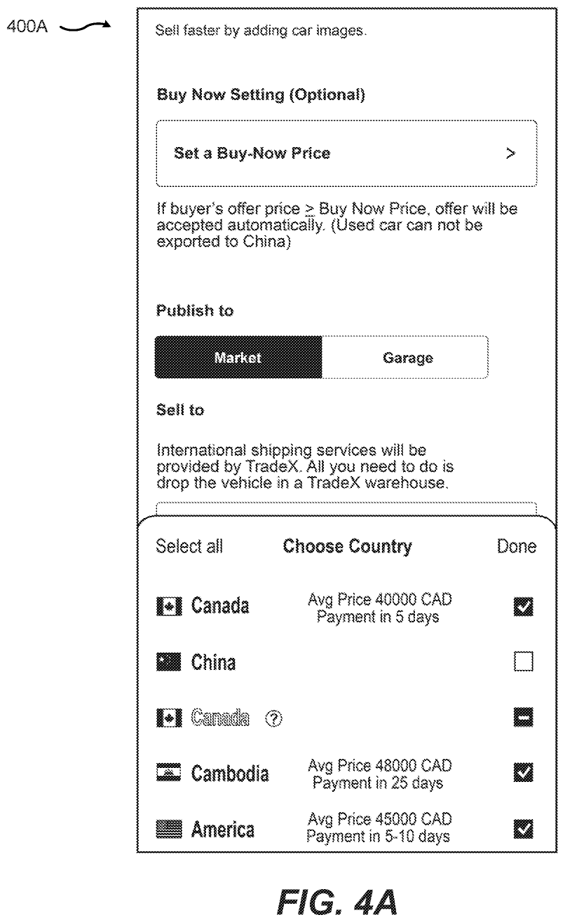

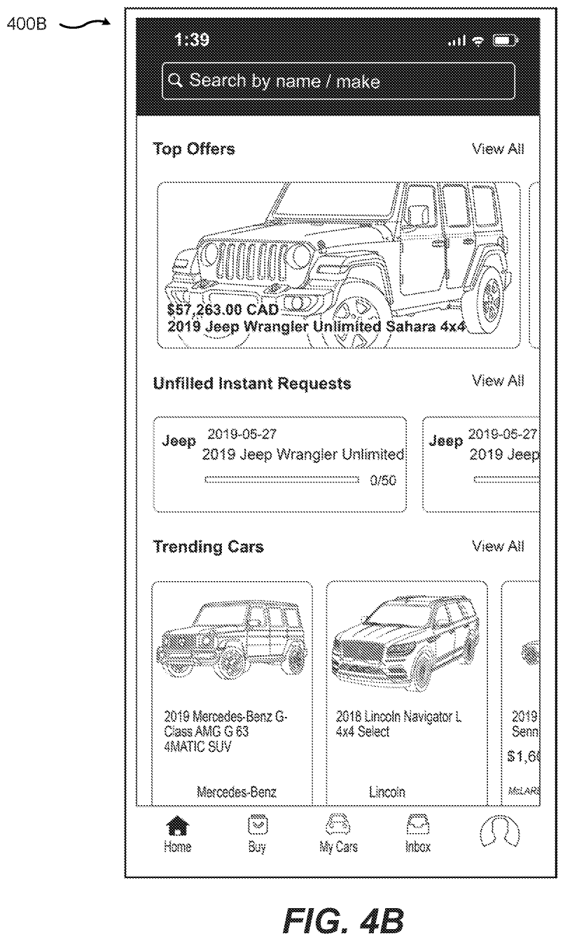

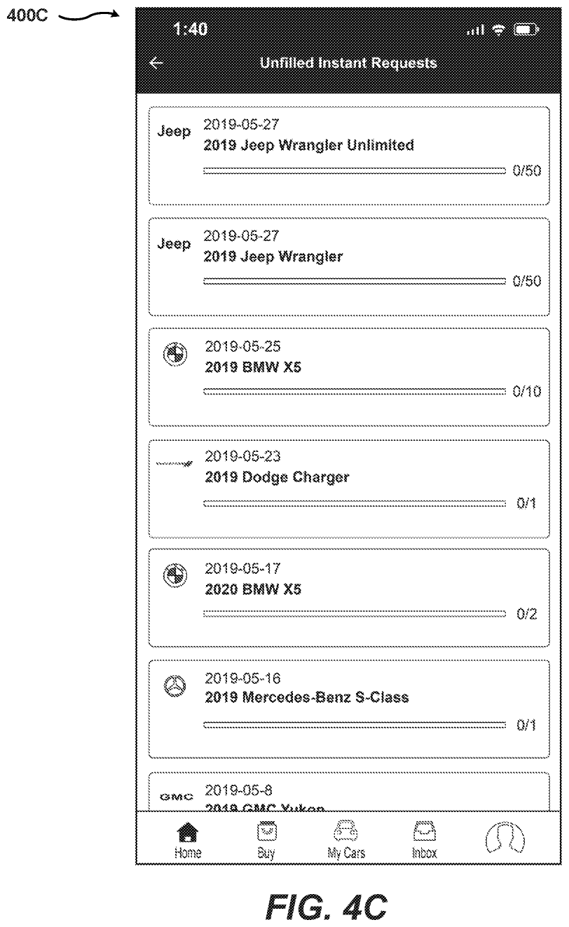

Finally, at step 360, the processor may cause the user interface of the user device to display offers to purchase the particular vehicle at the expected sales price for one or more of the geographic regions as described below in connection to FIG. 4A, as one non-limiting example.

In some embodiments, determining the expected sales price of the particular vehicle in each geographic region includes determining expected costs (e.g., using the cost data 147) associated with selling the particular vehicle in that region and subtracting those costs before outputting or displaying the expected sales price in that region to the user. As an example, there may be transaction costs imposed by an operator of the asset procurement system 100. There may also be various taxes and duties applied to a sale and other overhead costs such as storage, transportation, payments to other service providers, and so on. Costs may depend on the region of origin and destination of a vehicle being sold, date and/or location of manufacture, origin of various parts, and so on, as non-limiting examples.

In some such embodiments, determining the expected costs associated with selling the particular vehicle in each region may include retrieving, from a second electronic datastore, for a first geographic region, vehicle specification data indicating characteristic values indicating required vehicle characteristics of vehicles sold in that geographic region. Determining the expected costs may also include determining, using the characteristic values for the particular vehicle and the vehicle specification data (e.g., the specification data 145), that the particular vehicle lacks one or more of the required vehicle characteristics for sale in that geographic region; and that the particular vehicle may be modified to have the one or more required vehicle characteristics. Determining the expected costs may also include calculating, based on the one or more required vehicle characteristics and the characteristic values for the particular vehicle, an expected cost to modify the vehicle to have the one or more required vehicle characteristics. Determining the expected costs may also include incorporating the expected cost to modify the vehicle in the expected costs associated with selling the particular vehicle in the first geographic region. As an example, cars eligible for sale in a destination country may be required to have speedometers indicating speed in kilometers per hour. If a car has a speedometer indicating speed in miles per hour, it may be feasible to retrofit the vehicle for sale in the destination country if the costs of doing so are not too high. The asset procurement system 100 may use cost data (e.g., the cost data 147) to determine the cost of such modifications and other required costs to complete a prospective sales transaction. The asset procurement system may use the cost data or apply rules (e.g., rules included in the asset procurement instructions 152) to exclude prospective sales that require modifications having expected costs exceeding a threshold or which are otherwise undesirable.

In some embodiments, the processor may determine an expected time to complete a sale of the particular vehicle in each geographic region at the expected sales price for that geographic region. For example, the processor may use In such embodiments, the expected time to complete the sale may be displayed as shown in FIG. 4A, for example.

In some embodiments, the processor may automatically determine, for each of the geographic regions, a current exchange rate between a first currency and a currency associated with that geographic region; and cause the user interface to display the offers to purchase the particular vehicle in the first currency.

In some embodiments the processor automatically determine, for each geographic region, whether one or more prospective buyers exist in that region for the particular based on a portion of the sales records for that geographic region corresponding to the one or more prospective buyers. In such embodiments the processor may also receive one or more electronic messages indicating one or more prospective buyers willing to purchase the particular vehicle at the expected sales price in geographic regions corresponding to locations of the one or more prospective buyers. In such embodiments, causing the user interface of the user device to display the offers to purchase the particular vehicle includes displaying offers to purchase the particular vehicle at the expected sales price for the geographic regions corresponding to the locations of the one or more prospective buyers.

In some embodiments, the asset procurement system 100 can provide a user interface (“UI”) to users who are parties to various transactions in order to provide transaction-related information to the users, receive transaction-related information from the users, prompt the users to view or provide such information, prompt the users to complete tasks (which may be completed within the UI, within other electronic applications, or “offline”), or otherwise assist the users with completion of required tasks. For example, the asset procurement system 100 may allow users to execute trade agreements within the UI, as described further below in connection with FIGS. 4A-4C, FIG. 5, FIG. 6, and FIGS. 7A-7G. As a further example, once a trade agreement is signed, the asset procurement system 100 may facilitate further communication between the buyer (e.g., an importer) and the seller (e.g., an exporter) via the UI.

FIGS. 4A-4C show representations of example user interface displays (UIDs 400A, 400B, and 400C) that may be provided by the asset procurement system 100 as part of various functions.

FIG. 4A shows a representation of an example UID 400A in which a user attempting to sell a vehicle may select geographic regions (countries in this example) after the asset procurement system has processed information identifying a vehicle (e.g., as described in connection to the example method 300 of FIG. 3). As shown in the example UID 400A, the asset procurement system 100 may display an approximate expected sales price in each region, along with an estimate of the expected time to complete the transaction. Based on these preliminary estimates, the user may make selections instructing the asset procurement system 100 to only display offers for certain regions. Expected sales prices and expected times to complete sales transactions may be determined from previous sales records, user preferences and other data by employing regression algorithms (which may include principal component determination algorithms, as non-limiting examples), supervised learning algorithms, unsupervised learning algorithms, expert decision system algorithms, or any other suitable methods.

FIGS. 4B and 4C show representations of UIDs that may be presented as part of an “instant request function.” Buyers can submit information about vehicles they wish to purchase to the asset procurement system 100, including, as non-limiting examples, traits such as make, model, color, optional equipment, and so on. The asset procurement system 100 can aggregate this information and detailed information about the vehicles and can present graphical representations of the requests to prospective sellers, as shown in UID 400B of FIG. 4B. In addition to displaying individual unfulfilled requests, the system can track recent activity and can present vehicle requests relating to vehicle types or other parameters which have been the subject of increasing numbers of requests (i.e., “trending”). For such requests, the asset procurement system 100 may aggregate requests from multiple sources. The asset procurement system 100 may display such aggregated requests in a compact format as illustrated by the example UID 400C of FIG. 4C. Notably, the asset procurement system 100 may include additional information such as total number of current and/or recent requests for a particular vehicle type, along with the number of those requests which have been fulfilled (e.g., “0/10”, “10/50,” and so on), as illustrated by the example UID 400C of FIG. 4C.

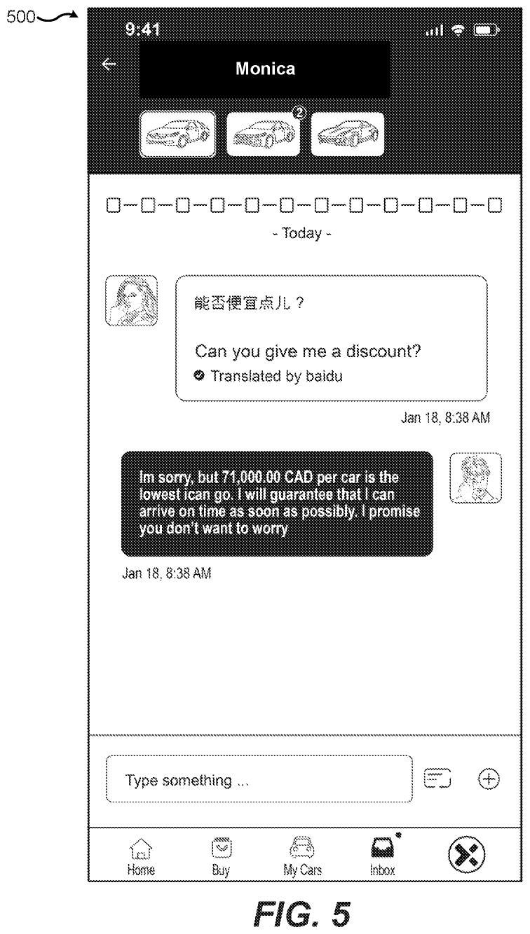

The asset procurement system 100 may provide a UI to facilitate communication between various parties to a transaction (or prospective transaction). FIG. 5 shows an example UID 500 in use by a first user (a seller in this example) to facilitate communication with a second user (a buyer in this example). As shown, the buyer is communicating in Chinese and the asset procurement system 100 automatically provides a translation to the seller, who communicates in English. As demonstrated, the UI can allow a user to communicate with multiple other users and can provide a graphical representation which identifies each communication (in this example, a photograph of a vehicle corresponding to a request for that vehicle type), along with notifications, when appropriate, that there are messages requiring the user's response or attention.

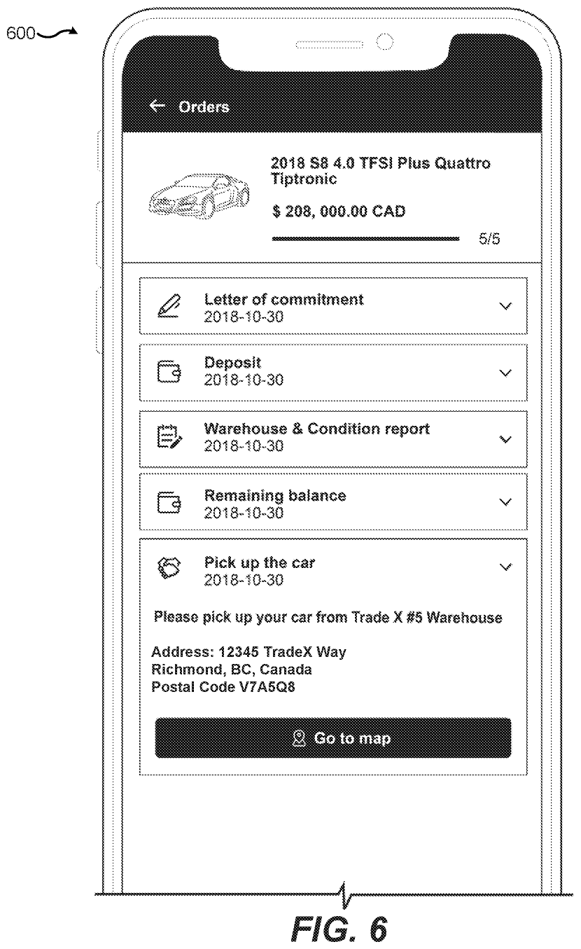

The asset procurement system 100 can enable users to track the status of various transactions to which they are party via one or more UIs supplied by the asset procurement system 100. FIG. 6 shows an example UID 600 related to this functionality. In the example UID 600, summary information identifying a transaction (for instance, the user in this example is the buyer of a vehicle identified as “2018 S8 4.0 TFSI Plus Quattro Tiptronic” for a purchase price of CAD 208,000.00) is displayed in a header. Below this header, various notifications and documents are displayed in a “timeline” format which can allow the user to see the progression of the transaction in chronological order. For instance, the UID 600 includes a notification that a Letter of commitment was signed, followed by a notice that a deposit was made, followed by a notice of inspection results upon arrival or dispatch of the asset from a warehouse, followed by a notice that the vehicle is ready for pickup. Finally, the asset procurement system 100 can provide instructions to assist the user in picking up the vehicle, as shown in UID 600. The asset procurement system 100 may provide additional information and resources within the UI. For example, the caret elements of the UI allow various notices to be expanded. The example user presented with the example UID 600 can view the letter of commitment within the UI by selecting the letter of commitment notification and/or selecting the caret-shaped UI element display next to that notification. Such caret-shaped elements can allow a user to view numerous pieces of high-level information and selectively view more information on an as-needed basis. As a further example, a seller may be shown a list of all pending orders in a single compact display. The seller may then choose to expand one, many, or all of the display elements for each transaction and enter appropriate information. For instance, if a seller has five orders awaiting confirmation of VIN numbers, the seller may expand all five order listings and enter the information for all five from a single UID.

As a further example, the UI may provide additional assistance, such as the button at the bottom of the example UID 600 labeled “Go to map,” which can allow the user to view a map to the location either within the UI or within a third-party application triggered by the asset procurement system 100 on a computing device of the user, such as a mobile phone, tablet, or computer.

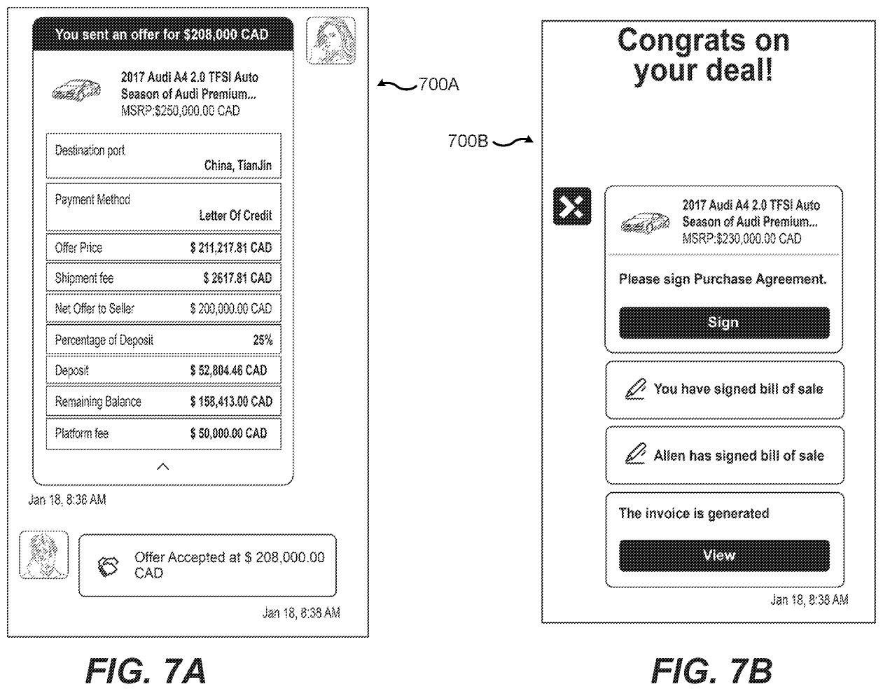

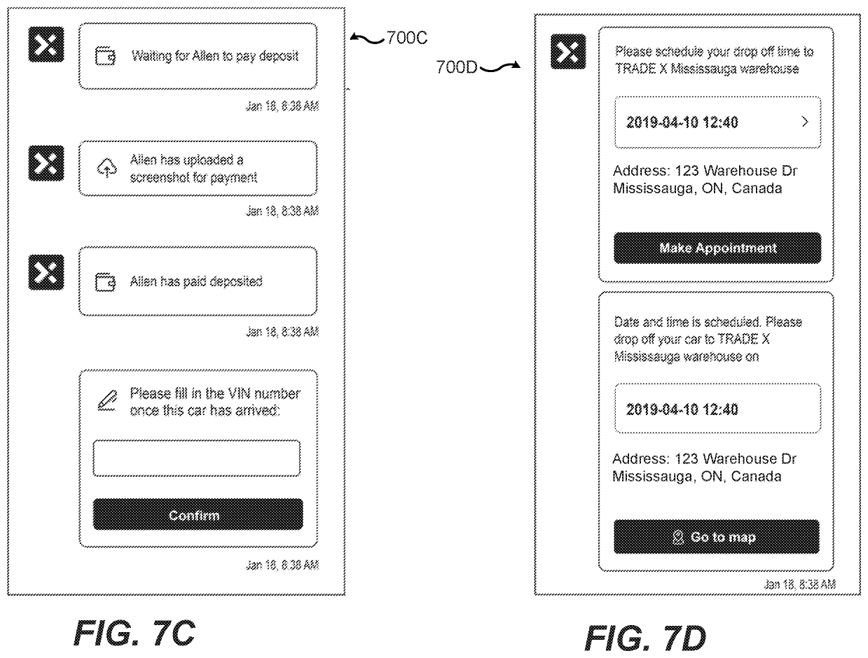

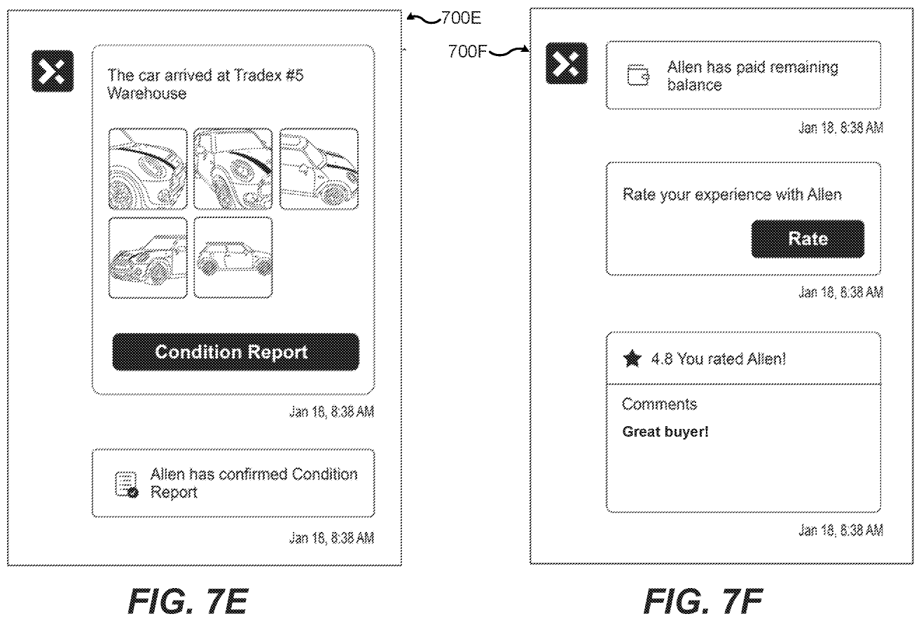

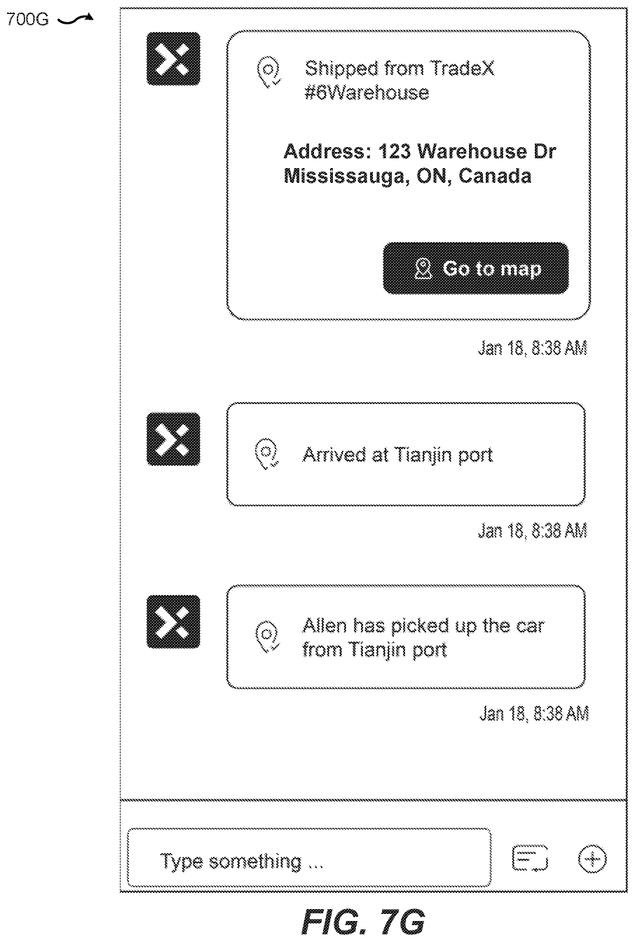

The asset procurement system 100 can learn from user behaviors using evolutionary algorithms to understand a user's habits and preferences as inferred from the user's previous interactions with the asset procurement system 100 and/or behaviors of other users which the system determines are similar to a particular user. The asset procurement system 100 may then provide customized notifications with information the asset procurement system 100 predicts the user will desire. FIGS. 7A-7G represent sequential UIDs of such customized notifications presented in a “timeline” or “conversation” format to a user as part of an example transaction. This UI function will be referred to henceforth as “the timeline” or “the timeline view.”

In the example UID 700A of FIG. 7A, a first example user representing a seller sends a sale offer of a vehicle to a second example user representing a buyer. Pertinent details of the offer are displayed for the seller's reference. This notification can be collapsible, allowing the seller in this example to see other information in the timeline while the summary data remains available for later viewing. The user may scroll up and down through the timeline view if there is more data than can be displayed on a single screen. After the buyer accepts the offer, a notification may appear in the seller's timeline view.

In the example UID 700B of FIG. 7B, the asset procurement system 100 may provide an additional, more prominent notification related to the accepted offer, which in this example includes the large text “Congrats on your deal!” This prominent notice, with a distinct visual style can provide a cue to the user that further actions may now be required. The asset procurement system 100 may now provide various smart notifications to the user (the seller in this example). These notifications may appear similar to communications from another user but may be visually distinguished so the user can recognize they originate from the asset procurement system 100. In this instance, the asset procurement system 100 can understand that signing a purchase agreement is the next step to complete the transaction and can provide a prompt to the user with a button interface element which allows the user to proceed to sign the agreement, either directly within the UI provided by the asset procurement system 100, or within another application triggered on the user's computing device by the UI provided by the asset procurement system 100 and executed by the user's computing device. Similarly, once the agreement is signed by each party, the asset procurement system 100 can provide a notification (if the system determines that doing so is appropriate to the state of the transaction and the user's preferences). Once all parties have signed, the asset procurement system 100 can intelligently provide a notification allowing the seller to review the invoice which has been automatically generated by the asset procurement system 100.

The process of providing notifications and prompts enabling the user to complete appropriate next steps may continue as further illustrated by the example UID 700C of FIG. 7C. Notably, once the vehicle of the previous example UIDs 700A and 700B has been paid for, the asset procurement system 100 may determine, as it does in the example transaction being described, that the seller must wait to receive a suitable vehicle from another location or from a supplier. The asset procurement system 100 can then provide an intelligent notification to the seller prompting the seller to enter the VIN number of the vehicle once it arrives. The asset procurement system 100 can receive the information and automatically update relevant regards, such as a bill of lading, bill of sale, customs forms, and so on. The system may also provide a notice (not shown) to the counterparty (i.e., the buyer) informing that the seller has received the vehicle, as evidenced by the VIN number. If a payment is due, the system may notify the buyer along with a notice of the deadline for payment. The system may also provide related notifications to other parties such as shipper, warehouse managers and so on. For instance, the asset procurement system 100 may provide a warehouse manager with a notification prompting confirmation of a bill of lading.

The transaction may proceed as illustrated by example UID 700D of FIG. 7D. In example UID 700D, the asset procurement system 100 can determine that the seller will drop off the vehicle at a particular warehouse which has either been chosen explicitly by the user or intelligently assigned by the asset procurement system 100 based on the user's preferences as understood by the asset procurement system 100 and/or pertinent details of the transaction, such as location of the vehicle, trade restrictions and other regulations, etc. The asset procurement system 100 can then provide a prompt for the user to schedule an appointment to drop off the vehicle. Once the user has selected a time, the asset procurement system 100 may, in some embodiments, automatically communicate with the warehouse and set the appointment on behalf of the user. As above, the asset procurement system 100 may provide notifications to other parties necessary to complete the transaction. For example, once an appointment is set on behalf of a user, the asset procurement system 100 may notify personnel who should be present for the appointment.

The transaction may proceed as illustrated by example UID 700E of FIG. 7E. Once the vehicle has been received by the warehouse, warehouse personnel can conduct an inspection. In some embodiments, the asset procurement system 100 may automatically process the inspection report, which optionally includes digital images and notices to the user, thereby providing UI elements allowing the user to review the report and images, if desired. The asset procurement system 100 may provide a related notification (not shown) to the counterparty (the buyer in this example) with a prompt and UI elements allowing the buyer to review the condition report.

The transaction proceeds as illustrated by example UID 700F of FIG. 7F. Notably the UID 700F provides a notification that full payment has been received from the buyer. A prompt is then provided for the seller to rate the buyer, and a similar prompt (not shown) is provided by the asset procurement system 100 to the buyer to rate the seller. These ratings are stored by the system. In some embodiments, the asset procurement system 100 may use rating data associated with buyers and sellers to intelligently recommend particular transactions. For instance, the system may determine, via a machine learning procedure that buyers prefer to pay more in order to buy from highly-rated sellers and/or that sellers prefer to provide discounts to sell to highly-rated buyers.

The transaction proceeds as illustrated by example UID 700G of FIG. 7G. The system can receive information indicating shipment of the vehicle from the destination warehouse. In some embodiments, the system may receive this information electronically from another computing system and automatically process it. In UID 700G, the asset procurement system 100 can provide a notification of shipment which includes a selectable UI element that can allow the user to track progress of the shipment on a map. In UID 700G, the asset procurement system 100 also displays an arrival notification and notification that the vehicle has been received by the buyer. As above, these notifications are automatically generated by the asset procurement system 100 upon receipt of pertinent information which may be manually entered into the system or may be provided automatically as part of a digital communication received from another computing system.

Various features and advantages of the invention are set forth in the following examples and in the Claims.

Example 1: An asset procurement coordination system having processing circuitry and memory coupled to the processing circuitry. The memory stores machine-readable instructions that, when executed by the processing circuitry, cause the processing circuitry to receive, via a user interface of a user device, vehicle identification information identifying a particular vehicle. The instructions, when executed by the processing circuitry, further cause the processing circuitry to determine, using the vehicle identification information, characteristic values indicating characteristics of the particular vehicle. The instructions, when executed by the processing circuitry, further cause the processing circuitry to retrieve, from a first electronic datastore, for each region belonging to a set of geographic regions, vehicle sales records, indicating vehicles purchased by one or more buyers in that region, and characteristics of the vehicles purchased by the one or more buyers in that region. The instructions, when executed by the processing circuitry, further cause the processing circuitry to determine for each region, using at least the characteristics of the particular vehicle, similar sales records for that region corresponding to vehicles similar to the particular vehicle, and an expected sales price of the particular vehicle in that region using the similar sales records for that region. The instructions, when executed by the processing circuitry, further cause the processing circuitry to and cause the user interface of the user device to display offers to purchase the particular vehicle at the expected sales price for one or more regions of the set of geographic regions.

Example 2: The system of Example 1 wherein the instructions, when executed by the processing circuitry to determine, for each region, the expected sales price of the particular vehicle in that region, cause the processing circuitry to determine expected costs for that region associated with selling the particular vehicle in that region and reduce the expected sales price by the expected costs for that region before said causing the user interface to display the offers to purchase the particular vehicle.

Example 3: The system of any of Examples 1-2 wherein the instructions, when executed by the processing circuitry to determine the expected costs associated with selling the particular vehicle in each region, cause the processing circuitry to retrieve, from a second electronic datastore, for a first region of the set of geographic regions, vehicle specification data indicating required vehicle characteristics in the first region. When executed by the processing circuitry to determine the expected costs associated with selling the particular vehicle in each region, the instructions also cause the processing circuitry to determine, using the characteristic values for the particular vehicle and the vehicle specification data, that the particular vehicle lacks one or more vehicle characteristics required in the first region and that the particular vehicle may be modified to have the one or more vehicle characteristics required in the first region. When executed by the processing circuitry to determine the expected costs associated with selling the particular vehicle in each region, the instructions also cause the processing circuitry to calculate, based on the one or more vehicle characteristics required in the first region, and the characteristic values for the particular vehicle, an expected cost to modify the vehicle to have the one or more required vehicle characteristics in the first region. When executed by the processing circuitry to determine the expected costs associated with selling the particular vehicle in each region, the instructions also cause the processing circuitry to incorporate the expected cost to modify the vehicle in the expected costs associated with selling the particular vehicle in the first region in an expected cost associated with selling the particular vehicle in the first region.

Example 4: The system of any of Examples 1-3 wherein the instructions, when executed by the processing circuitry, also cause the processing circuitry to determine an expected time to complete a sale of the particular vehicle in each region at the expected sales price for that region; and transmit an electronic message causing the user interface of the user device to display the expected time to complete the sale of the particular vehicle for each of the one or more regions with the offers to purchase the particular vehicle at the expected sales price for the one or more of the regions.

Example 5: The system of any of Examples 1-4 wherein the instructions, when executed by the processing circuitry, cause the processing circuitry to automatically determine, for each region, a current exchange rate between a first currency and a currency associated with that region and cause the user interface to display the offers to purchase the particular vehicle in the first currency.

Example 6: The system of any of Examples 1-5, wherein the instructions, when executed by the processing circuitry, also cause the processing circuitry to automatically determine, for each region, whether one or more prospective buyers exist in that region for the particular based on a portion of the sales records for that region corresponding to the one or more prospective buyers. The instructions also cause processing circuitry to receive one or more electronic messages indicating one or more prospective buyers willing to purchase the particular vehicle at the expected sales price in regions corresponding to locations of the one or more prospective buyers. The instructions also cause processing circuitry to cause the user interface of the user device to display the offers to purchase the particular vehicle included displaying offers to purchase the particular vehicle at the expected sales price for the regions corresponding to the locations of the one or more prospective buyers.

Example 7: A computer-implemented method of automatically coordinating asset procurement. The method includes receiving, via a user interface of a user device, vehicle identification information identifying a particular vehicle; determining, using the vehicle identification information, characteristic values indicating characteristics of the particular vehicle. The method also includes retrieving, from a first electronic datastore, for each region belonging to a set of geographic regions, vehicle sales records, indicating vehicles purchased by one or more buyers in that region, and characteristics of the vehicles purchased by the one or more buyers in that region. The method also includes determining for each region, using at least the characteristics of the particular vehicle: similar sales records that correspond to vehicles similar to the particular vehicle; and an expected sales price of the particular vehicle in that region using the similar sales records for that region. The method also includes transmitting an electronic message causing the user interface of the user device to display offers to purchase the particular vehicle at the expected sales price for one or more of the regions.

Example 8: A method as in Example 7, wherein determining, for each region, the expected sales price of the particular vehicle in that region includes determining expected costs associated with selling the particular vehicle in that region and reducing the expected sales price for that region by the expected costs for that region before causing the user interface to display the offers to purchase the particular vehicle.

Example 9: A method as in any of Examples 7-8, wherein determining the expected costs associated with selling the particular vehicle in each region includes retrieving, from a second electronic datastore, for a first region of the set of geographic regions, vehicle specification data indicating characteristic values indicating required vehicle characteristics in the first region. The method also includes determining, using the characteristic values for the particular vehicle and the vehicle specification data, that: the particular vehicle lacks one or more vehicle characteristics required in the first region and that the particular vehicle may be modified to have the one or more vehicle characteristics required in the first region. The method also includes and calculating, based on the one or more vehicle characteristics required in the first region and the characteristic values for the particular vehicle, an expected cost to modify the vehicle to have the one or more vehicle characteristics required in the first region. The method also includes and incorporating the expected cost to modify the vehicle in expected costs associated with selling the particular vehicle in the first region.

Example 10: A method as in any of Examples 7-9, wherein the method also includes determining an expected time to complete a sale of the particular vehicle in each region at the expected sales price for that region. The method also includes transmitting an electronic message causing the user interface of the user device to display the expected time to complete the sale of the particular vehicle for each of the one or more regions with the offers to purchase the particular vehicle at the expected sales price for the one or more of the regions.

Example 11: A method as in any of Examples 7-10, wherein the method also includes automatically determining, for each region, a current exchange rate between a first currency and a currency associated with that region. The method also includes causing the user interface to display the offers to purchase the particular vehicle in the first currency.

Example 12: A method as in any of Examples 7-11, wherein the method also includes automatically determining, for each region, whether one or more prospective buyers exist in that region for the particular vehicles based on a portion of the sales records for that region corresponding to the one or more prospective buyers. The method also includes receiving one or more electronic messages indicating one or more prospective buyers willing to purchase the particular vehicle at the expected sales price in regions corresponding to locations of the one or more prospective buyers. The message causing the user interface of the user device to display the offers to purchase the particular vehicle causes the user interface to display offers to purchase the particular vehicle at the expected sales price for the regions corresponding to the locations of the one or more prospective buyers.

Example 13: A computer program product including a non-transitory storage medium storing instructions. The instructions are configured to cause processing circuitry of a computing device to receive, via a user interface of a user device, vehicle identification information identifying a particular vehicle. The instructions are also configured to cause the processing circuitry to determine, using the vehicle identification information, characteristic values indicating characteristics of the particular vehicle. The instructions are also configured to cause the processing circuitry to retrieve, from a first electronic datastore, for each region belonging to a set of geographic regions, vehicle sales records indicating vehicles purchased by one or more buyers in that region, and characteristics of the vehicles purchased by the one or more buyers in that region. The instructions are also configured to cause the processing circuitry to determine for each region, using at least the characteristics of the particular vehicle, similar sales records that correspond to vehicles similar to the particular vehicle and an expected sales price of the particular vehicle in that region using the similar sales records for that region. The instructions are also configured to cause the processing circuitry to transmit an electronic message causing the user interface of the user device to display offers to purchase the particular vehicle at the expected sales price for one or more of the regions.

Example 14: A computer program product as in Example 13, wherein the instructions are configured to cause the processing circuitry, when determining, for each region, the expected sales price of the particular vehicle in that region, to determine expected costs associated with selling the particular vehicle in that region and reduce the expected sales price by the expected costs for that region before said causing the user interface to display the offers to purchase the particular vehicle.

Example 15: A computer program product as in any of Examples 13-14, wherein the instructions are configured to cause the processing circuitry, when determining the expected costs associated with selling the particular vehicle in each region, to retrieve, from a second electronic datastore, for a first region of the set of geographic regions, vehicle specification data indicating characteristic values indicating one or more required vehicle characteristics in the first region. The instructions are also configured to cause the processing circuitry to determine, using the characteristic values for the particular vehicle and the vehicle specification data, that the particular vehicle lacks one or more one or more vehicle characteristics required in the first region; and that the particular vehicle may be modified to have the on one or more vehicle characteristics required in the first region. The instructions are also configured to cause the processing circuitry to calculate, based on the one or more vehicle characteristics required in the first region and the characteristic values for the particular vehicle, an expected modification cost to modify the vehicle to have the one or more vehicle characteristics required in the first region. The instructions are also configured to cause the processing circuitry to and incorporate the expected modification cost to modify the vehicle in the expected costs associated with selling the particular vehicle in the first region.

Example 16: A computer program product as in any of Examples 13-15, wherein the instructions are also configured to cause the processing circuitry to determine an expected time to complete a sale of the particular vehicle in each region at the expected sales price for that region. The instructions are also configured to cause the processing circuitry to transmit an electronic message causing the user interface of the user device to display the expected time to complete the sale of the particular vehicle for each of the one or more regions with the offers to purchase the particular vehicle at the expected sales price for the one or more of the regions.

Example 17: A computer program product as in any of Examples 13-16, wherein the instructions are also configured to cause the processing circuitry to automatically determine, for each of the regions, a current exchange rate between a first currency and a currency associated with that region. The instructions are also configured to cause the processing circuitry to cause the user interface to display the offers to purchase the particular vehicle in the first currency.

Example 18: A computer program product as in any of Examples 13-17, wherein the instructions are also configured to cause the processing circuitry to automatically determine, for each region, whether one or more prospective buyers exist in that region for the particular vehicle based on a portion of the sales records for that region corresponding to the one or more prospective buyers. Thee instructions are also configured to cause the processing circuitry to receive one or more electronic messages indicating one or more prospective buyers willing to purchase the particular vehicle at the expected sales price in regions corresponding to locations of the one or more prospective buyers. The message causing the user interface of the user device to display the offers to purchase the particular vehicle causes the user interface to display offers to purchase the particular vehicle at the expected sales price for the regions corresponding to the locations of the one or more prospective buyers.

I claim:

1. An asset procurement coordination system, the system comprising:
processing circuitry and memory coupled to the processing circuitry, the memory storing machine-readable instructions that, when executed by the processing circuitry, cause the processing circuitry to:
receive, via a user interface of a user device, vehicle identification information identifying a particular vehicle;
determine, using the vehicle identification information, characteristic values indicating characteristics of the particular vehicle;
retrieve, from a first electronic datastore, for each region belonging to a set of geographic regions, vehicle sales records, indicating vehicles purchased by one or more buyers in that region, and characteristics of the vehicles purchased by the one or more buyers in that region;
determine for each region, using at least the characteristics of the particular vehicle:
similar sales records for that region corresponding to vehicles similar to the particular vehicle; and
an expected sales price of the particular vehicle in that region using the similar sales records for that region; and
cause the user interface of the user device to display offers to purchase the particular vehicle at the expected sales price for one or more regions of the set of geographic regions.

2. The system of claim 1, wherein the instructions, when executed by the processing circuitry to determine, for each region, the expected sales price of the particular vehicle in that region, cause the processing circuitry to:
determine expected costs for that region associated with selling the particular vehicle in that region and reduce the expected sales price by the expected costs for that region before said causing the user interface to display the offers to purchase the particular vehicle.

3. The system of claim 2, wherein the instructions, when executed by the processing circuitry to determine the expected costs associated with selling the particular vehicle in each region, cause the processing circuitry to:
retrieve, from a second electronic datastore, for a first region of the set of geographic regions, vehicle specification data indicating required vehicle characteristics in the first region;
determine, using the characteristic values for the particular vehicle and the vehicle specification data, that:
the particular vehicle lacks one or more vehicle characteristics required in the first region;
the particular vehicle may be modified to have the one or more vehicle characteristics required in the first region; and
calculate, based on the one or more vehicle characteristics required in the first region; and the characteristic values for the particular vehicle, an expected cost to modify the vehicle to have the one or more required vehicle characteristics in the first region; and
incorporate the expected cost to modify the vehicle in the expected costs associated with selling the particular vehicle in the first region in an expected cost associated with selling the particular vehicle in the first region.

4. The system of claim 2, wherein the instructions, when executed by the processing circuitry, further cause the processing circuitry to:
determine an expected time to complete a sale of the particular vehicle in each region at the expected sales price for that region; and
transmit an electronic message causing the user interface of the user device to display the expected time to complete the sale of the particular vehicle for each of the one or more regions with the offers to purchase the particular vehicle at the expected sales price for the one or more of the regions.

5. The system of claim 1, wherein the instructions, when executed by the processing circuitry, further cause the processing circuitry to:
automatically determine, for each region, a current exchange rate between a first currency and a currency associated with that region; and
cause the user interface to display the offers to purchase the particular vehicle in the first currency.

6. The system of claim 1, wherein the instructions, when executed by the processing circuitry, further cause the processing circuitry to:
automatically determine, for each region, whether one or more prospective buyers exist in that region for the particular based on a portion of the sales records for that region corresponding to the one or more prospective buyers;
receive one or more electronic messages indicating one or more prospective buyers willing to purchase the particular vehicle at the expected sales price in regions corresponding to locations of the one or more prospective buyers; and
wherein causing the user interface of the user device to display the offers to purchase the particular vehicle comprises displaying offers to purchase the particular vehicle at the expected sales price for the regions corresponding to the locations of the one or more prospective buyers.

7. A computer-implemented method of automatically coordinating asset procurement, the method comprising:
receiving, via a user interface of a user device, vehicle identification information identifying a particular vehicle;
determining, using the vehicle identification information, characteristic values indicating characteristics of the particular vehicle;
retrieving, from a first electronic datastore, for each region belonging to a set of geographic regions, vehicle sales records, indicating vehicles purchased by one or more buyers in that region, and characteristics of the vehicles purchased by the one or more buyers in that region;
determining for each region, using at least the characteristics of the particular vehicle:
similar sales records that correspond to vehicles similar to the particular vehicle; and
an expected sales price of the particular vehicle in that region using the similar sales records for that region; and
transmitting an electronic message causing the user interface of the user device to display offers to purchase the particular vehicle at the expected sales price for one or more of the regions.

8. The method of claim 7, wherein determining, for each region, the expected sales price of the particular vehicle in that region comprises:
determining expected costs associated with selling the particular vehicle in that region and reducing the expected sales price for that region by the expected costs for that region before causing the user interface to display the offers to purchase the particular vehicle.

9. The method of claim 8, wherein determining the expected costs associated with selling the particular vehicle in each region comprises:
retrieving, from a second electronic datastore, for a first region of the set of geographic regions, vehicle specification data indicating characteristic values indicating required vehicle characteristics in the first region;
determining, using the characteristic values for the particular vehicle and the vehicle specification data, that:
the particular vehicle lacks one or more vehicle characteristics required in the first region;
the particular vehicle may be modified to have the one or more vehicle characteristics required in the first region; and
calculating, based on the one or more vehicle characteristics required in the first region and the characteristic values for the particular vehicle, an expected cost to modify the vehicle to have the one or more vehicle characteristics required in the first region; and
incorporating the expected cost to modify the vehicle in expected costs associated with selling the particular vehicle in the first region.

10. The method of claim 8, further comprising:
determining an expected time to complete a sale of the particular vehicle in each region at the expected sales price for that region; and
transmitting an electronic message causing the user interface of the user device to display the expected time to complete the sale of the particular vehicle for each of the one or more regions with the offers to purchase the particular vehicle at the expected sales price for the one or more of the regions.

11. The method of claim 7, further comprising:
automatically determining, for each region, a current exchange rate between a first currency and a currency associated with that region; and
causing the user interface to display the offers to purchase the particular vehicle in the first currency.

12. The method of claim 7, further comprising:
automatically determining, for each region, whether one or more prospective buyers exist in that region for the particular vehicles based on a portion of the sales records for that region corresponding to the one or more prospective buyers;
receiving one or more electronic messages indicating one or more prospective buyers willing to purchase the particular vehicle at the expected sales price in regions corresponding to locations of the one or more prospective buyers; and
wherein the message causing the user interface of the user device to display the offers to purchase the particular vehicle causes the user interface to display offers to purchase the particular vehicle at the expected sales price for the regions corresponding to the locations of the one or more prospective buyers.

13. A computer program product comprising a non-transitory storage medium storing instructions configured to cause processing circuitry of a computing device to:
receive, via a user interface of a user device, vehicle identification information identifying a particular vehicle;
determine, using the vehicle identification information, characteristic values indicating characteristics of the particular vehicle;
retrieve, from a first electronic datastore, for each region belonging to a set of geographic regions, vehicle sales records indicating vehicles purchased by one or more buyers in that region, and characteristics of the vehicles purchased by the one or more buyers in that region;
determine for each region, using at least the characteristics of the particular vehicle:
similar sales records that correspond to vehicles similar to the particular vehicle; and
an expected sales price of the particular vehicle in that region using the similar sales records for that region; and
transmit an electronic message causing the user interface of the user device to display offers to purchase the particular vehicle at the expected sales price for one or more of the regions.

14. The computer program product of claim 13, wherein the instructions are further configured to cause the processing circuitry, when determining, for each region, the expected sales price of the particular vehicle in that region, to:
determine expected costs associated with selling the particular vehicle in that region and reduce the expected sales price by the expected costs for that region before said causing the user interface to display the offers to purchase the particular vehicle.

15. The computer program product of claim 14, wherein the instructions are further configured to cause the processing circuitry, when determining the expected costs associated with selling the particular vehicle in each region, to:
retrieve, from a second electronic datastore, for a first region of the set of geographic regions, vehicle specification data indicating characteristic values indicating one or more required vehicle characteristics in the first region;
determine, using the characteristic values for the particular vehicle and the vehicle specification data, that:
the particular vehicle lacks one or more one or more vehicle characteristics required in the first region;
the particular vehicle may be modified to have the on one or more vehicle characteristics required in the first region; and
calculate, based on the one or more vehicle characteristics required in the first region\and the characteristic values for the particular vehicle, an expected modification cost to modify the vehicle to have the one or more vehicle characteristics required in the first region; and
incorporate the expected modification cost to modify the vehicle in the expected costs associated with selling the particular vehicle in the first region.

16. The computer program product of claim 14, wherein the instructions are further configured to cause the processing circuitry to:
determine an expected time to complete a sale of the particular vehicle in each region at the expected sales price for that region; and
transmit an electronic message causing the user interface of the user device to display the expected time to complete the sale of the particular vehicle for each of the one or more regions with the offers to purchase the particular vehicle at the expected sales price for the one or more of the regions.

17. The computer program product of claim 13, wherein the instructions are further configured to cause the processing circuitry to:
automatically determine, for each of the regions, a current exchange rate between a first currency and a currency associated with that region; and
cause the user interface to display the offers to purchase the particular vehicle in the first currency.

18. The computer program product of claim 13, wherein the instructions are further configured to cause the processing circuitry to:
automatically determine, for each region, whether one or more prospective buyers exist in that region for the particular based on a portion of the sales records for that region corresponding to the one or more prospective buyers;
receive one or more electronic messages indicating one or more prospective buyers willing to purchase the particular vehicle at the expected sales price in regions corresponding to locations of the one or more prospective buyers; and
wherein the message causing the user interface of the user device to display the offers to purchase the particular vehicle causes the user interface to display offers to purchase the particular vehicle at the expected sales price for the regions corresponding to the locations of the one or more prospective buyers.

19. An asset procurement coordination system, the system comprising:
processing circuitry and memory coupled to the processing circuitry, the memory storing machine-readable instructions that, when executed by the processing circuitry, cause the processing circuitry to:
receive, via a user interface of a user device, vehicle identification information identifying a particular vehicle;
determine, using the vehicle identification information, characteristic values indicating technical characteristics of the particular vehicle;
retrieve, from a first electronic datastore, for each region belonging to a set of geographic regions, vehicle properties, indicating one or a group of vehicles having similar properties, and the technical characteristics of the one or group of vehicles having similar vehicle properties in that region;
determine for each region, using at least the technical characteristics of the particular vehicle:
similar vehicles with similar properties for that region corresponding to vehicles technically similar to the particular vehicle; and
an expected calculated property of the particular vehicle in that region using the vehicles with similar properties for that region; and
cause the user interface of the user device to display the particular vehicle with the expected calculated property for one or more regions of the set of geographic regions.
